(19) United States
(12) Patent Application Publication
(10) Pub. No.: US 2003/0126119 A1
(43) Pub. Date: Jul. 3, 2003

(54) Method of searching a specific website by means of a numerical code combined from a plurality of specific phone numbers

(76) Inventor: Chung Yu Lin, Kaohsiung (TW)

Correspondence Address: Raymond Y.C. Chan, 1050 Oakdale Lane, Arcadia, CA, 91006, US

(21) Appl. No.: 10/040,311

(22) Filed: Dec. 31, 2001

(51) Int. Cl. G06F 7/00

(52) U.S. Cl. 707/3

(57) ABSTRACT

A method for searching a specific website includes the steps of providing an information center which linked to a database for storing website identifiers and a plurality of corresponding phone codes, wherein the information center is arranged to be accessed through electronic communication network; receiving a search request from a user by the information center via the electronic communication network, wherein the search request includes a numerical search code; searching the numerical search code from the database by matching the search code with the phone codes stored in the database to form a search result; and providing a search result to the user.

### BACKGROUND OF THE PRESENT INVENTION

1. Field of Invention

The present invention relates to a searching method, and more particularly to a method of searching a website using a numerical code combined by a plurality of specific phone numbers which are assigned to that website.

2. Description of Related Arts

In this information era, it is indisputably that most of the people simply cannot afford to ignore the importance and impact of Internet. Nowadays, over twenty millions websites have been set up all around the world for different kinds of purposes wherein each website must have a domain name for distinguishing itself by any others. Accordingly, there are corresponding numbers (over twenty millions) of registered domain names exist and are ready to be accessed by people all over the world through World Wide Web (WWW). When an Internet user want to access a particular website, he/she is required to enter the domain name in which the particular website holds to the WWW.

A particular domain name, generally refers to a series of wordings or characters used to represent a particular Internet Protocol Address (IP Address) of a particular website in the World Wide Web, wherein a particular domain name can only be used to represent only one IP address, i.e. one particular website. Currently, The Internet Corporation for Assigned Names and Numbers (ICANN) is responsible for managing and coordinating the registration of domain names all over the world. It established seven generic Top Level Domains (gTLD) in 1985 to group, according to the nature of a particular organization that holds a particular website, all websites in seven categories, which are: .com, .org, .net, .gov, .int, .mil and .edu. However, with the ever-increasing demand of Internet usage, the ICANN has further established several gTLDs since May, 2001 to further categorize the nature of websites' holders. The newly added gTDLs are: .aero(for aerospace industry), .biz(for business), .corp(for corporation), .pro(for professional sectors), .info(for multi-purpose websites), .name(for personal websites), .museum(for museum).

The above-mentioned scenarios possess a lot of conflicts and problems as who should own a particular domain name and as how can one finds his/her desirable website, the following is a brief summary:

First, because a particular domain name can only registered once, if someone has registered a particular domain name, any one else then cannot use that particular name as the domain main. Currently, the registration of domain name is based on ‘first come, first serve’ rule. That is to say, the first who first registers a particular domain name has the monopoly right to use it and that particular domain name cannot be registered again.

Since a particular domain main can, as in the case of trademark, identify and distinguish an organization from others, it can be an indispensable asset to the organization, especially when the organization is prominent or an internationally recognized corporation.

Therefore, some so-called Cyber-squatters who intentionally register bunch of domain names that contain characters or wordings of those prominent corporation names in an attempt to own the prominently recognized names prior to the organization themselves. Then, they can sell those domain names to the corresponding organizations in order to gain benefits.

Then, in an attempt to solve the problem of Cyber-squatters, the World Intellectual Property Organization Arbitration Mediation Center and ICANN are actively dealing with conflicts arising from domain name owning rights and other related issues. On illustrative example is that the holder of prominent ‘yahoo’ website has successfully claimed tens of ‘yahoo’ related domain name. However, the above mentioned arbitration organization has no legal authority to deal with the conflicts. What they do are from the viewpoint of administration procedures and registration system. As a result, their arbitrative power or authority is unduly limited.

Third, on the other hand, from the view point of Internet end-user, searching a particular website can be a frustrating task, especially searching those websites that have domain names different from the respective organization's name. A domain name usually consists of a plurality of words or characters that are not easy to remember. Very often, the user may guess a website's domain name by entering the full name or the short form of the intent-to-find organization (e.g. SONY, IBM, etc.). Unfortunately, this method is not the golden rule to reach a desirable website. Therefore, more often, the user has to depend on experience or other sources (e.g. advertisement) to find out the domain name of a desirable website and store it in his/her own computer or address book.

Further still, occasionally, if the user is traveling or going for business trips, he/she may not have the opportunity to user the computer that he/she usually uses. As a result, some desirable or necessary websites addresses may not come with the user. Then, when the user want to access to those sites, he/she has to either search again or call for help from his/her home or company. Even the user is able to call for help, say, by telephone, pronunciation similarity of the characters of a domain name may cause significant confusion. For example, one is difficult to distinguish ‘b’ and ‘d’ in telephone conversation. Therefore, the user may incorrectly regard ‘b’ as ‘d’, or vice versa.

Even if the user can finally call for help, say by telephone, during the process of searching the domain names, the user may have already wasted valuable business time. If the user is in a region in which its time zone is different from his/her company's time zone, the searching time may be even further unnecessarily prolonged.

### SUMMARY OF THE PRESENT INVENTION

A main object of the present invention is to provide a method of searching a specific website by means of a numerical code combined from a plurality of specific phone numbers associated with that website, wherein the numerical code of that website and its actual domain name are registered together with a server, such that when a user wants to search for that specific website, he/she can just search by the numerical code without needing to know the domain name of that website.

Another object of the present invention is to provide a method of searching a specific website by means of a numerical code combined from a plurality of specific phone numbers associated with that website, wherein the numerical code of that website and its actual domain name are registered together with a server to act as an unique identifier of that specific website, so as to preventing a desirable domain name is pre-registered by Cyber-squatters.

Another object of the present invention is to provide a method of searching a specific website by means of a numerical code combined from a plurality of specific phone numbers associated with that website, wherein more than one numerical codes of that website and its actual domain name are allowed to register with a server to act as an unique identifier of that specific website, so that a user of can be able to search that particular website by any one of the numerical codes.

Another object of the present invention is to provide a method of searching a specific website by means of a numerical code combined from a plurality of specific phone numbers associated with that website, so as to reduce the difficulties and problems aroused when a user searches or locates that particular website by the website's full domain name.

Another object of the present invention is to provide a method of searching a specific website by means of a numerical code combined from a plurality of specific phone numbers associated with that website, wherein the phone numbers are registered with a website holder's local telecommunication networks and are publicly available in telephone directories, so as to minimize the difficulty for a user in finding the required phone numbers.

Accordingly, in order to accomplish the above objects, the present invention provides a method for searching a specific website, comprising the steps of:

(a) providing an information center linked with a database for storing website identifiers and a plurality of corresponding phone codes, wherein said information center is arranged to be accessed through electronic communication network;

(b) receiving a search request from a user by said information center, wherein said search request includes a numerical search code;

(c) searching said numerical search code from said database by matching said search code with said phone codes stored in said database to form a search result; and

(d) providing a search result to said user.

### BRIEF DESCRIPTION OF THE DRAWINGS

FIG. 1 is a flow diagram of a method of searching specific website by means of a numerical code combined from a plurality of phone numbers according to a first preferred embodiment of the present invention.

FIG. 2 is a schematic diagram of the search request web page according to the first preferred embodiment of the present invention.

FIG. 3 is a flow diagram of a method of searching specific website by means of a numerical code combined from a plurality of phone numbers according to a second preferred embodiment of the present invention.

### DETAILED DESCRIPTION OF THE PREFERRED EMBODIMENT

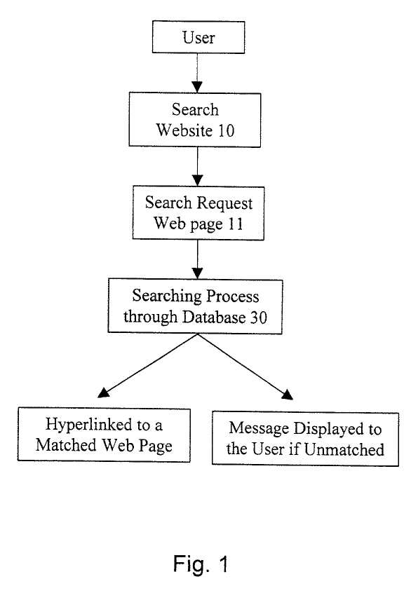

Referring to FIG. 1 of the drawings, a method of searching a specific website by means of a numerical code according to a first preferred embodiment of the present invention is illustrated. According to the first preferred embodiment, the searching method comprises the steps of:

(a) Providing an information center which linked to a database for storing website identifiers and a plurality of corresponding phone codes, wherein the information center is arranged to be accessed through electronic communication network; and

(b) receiving a search request from a user by the information center via the electronic communication network, wherein the search request includes a numerical search code.

The information center is pre-loaded into a computer system which comprises at least a display unit and a central processor. The computer system is connected with a plurality of similar computer systems through electronic communication network, such as Internet. Accordingly, the information center is linked to the World Wide Web (WWW) wherein any computer system linked in the World Wide Web can access to the information center.

The information center comprises a search website 10 linked to a particular server 20 through World Wide Web, wherein the search website 10 comprises a search request web page 11. The search request web page 11 can be a home page of that search website 10, or it can be one of the web pages under the search website 10.

The database 30 is launched by the server 20 and stores website identifiers and their corresponding phone codes of a plurality of websites all around the world and for a variety of fields. The website identifiers can be the conventional identification of a particular website, such as the domain names. According to the first preferred embodiment of the present invention, for each of the domain names stored, a unique phone code is assigned to a website identifier so that each website is not only represented by its domain name, but also by a unique phone code corresponding to the domain name.

Since the information center is linked to the World Wide Web through Internet, any other computer systems which is also linked to the World Wide Web can access to the database by accessing to the search website 10. Accordingly, the search request web page 11 is designed and programmed by any one of software which supports World Wide Web application, such as XHTML, XML, C, C++ and Java etc.

Each of the phone codes takes the following format: Country Code-Area Code-Local Phone Number, wherein the local phone number is the local phone number of the corresponding website's holder, the area code is the official telephone area code of that website holder, and the country code is the international telephone country code of that website's holder. Depending on the nature of the website, the website's holder can be a corporation, an institution, or a company. Nevertheless, they should have a local contact telephone number. It is worth to stress that the uniqueness of each phone code can be ensured by combining the local phone number with the area code and the country code in which the corresponding website's holder.

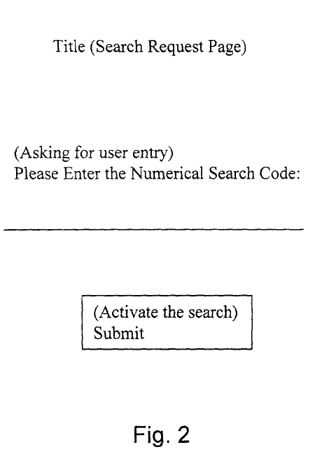

Referring to FIG. 2 of the drawings, the search request web page 11 contains at least a section that allows the user of this searching method to input a numerical search code which is known to the user. The numerical search code is the phone code of the website that the user intents to search. In other words, the numerical search code is also in the format of Country Code-Area Code-Local Phone Number. Accordingly, the user is required to enter the corresponding numerical phone code in order to search for the website that he/she wants to access.

However, it is worth mentioning that the holder of the website stored in the database 30 shouldn't be limited to organizations. Accordingly, the ‘Local Phone Number’ components of the numerical search code and the phone code can be replaced by ‘Individual Mobile Phone Number’ which allows individual website holders to utilize the searching method of the present invention.

Referring to FIGS. 1 to 2 of the drawings, the method of searching a specific website according to the first preferred embodiment further comprises the steps of:

(c) searching the numerical search code from the database by matching the search code with the phone codes stored in the database to form a search result; and

(d) providing a search result to the user.

The search request web page 11 must further contains an activation section that allows the user to activate the searching process of step (c) through the activation section.

The searching process is carried out by comparing the entered numerical search code with each of the stored phone codes which represent a unique website. If the numerical phone code matches one of the stored phone codes, a search result which contains the corresponding website having a domain name represented by that phone code will be hyperlinked to the user's computer system. In other words, the original search request web page 11 will be replaced by the web page of the website having the phone code matched with the numerical search code of the user. That is to say, the desirable or the required website is linked automatically to the computer's system via Internet.

However, if the numerical search code doesn't match with all the stored phone codes in the database 30, a search result which contains a re-enter web page will be automatically opened which allows the user to enter another numerical search code, and preferably, tells the user that the previous search turns out with no suitable website. Nevertheless, an unmatched message will be directed to the user.

Alternatively, when the numerical search code matches with one of the stored phone codes, a the search result can be shown by opening another web page which is the home page or the web pages of the matched website. In other words, the original search request web page 11 will not be replaced by the web page of the matched website. In addition, a new search request web page 11 can be shown to replace the original search report web page for further searching, if desired.

Moreover, for each of the website identifier stored in the database 30, it can have more than one phone codes. When the numerical search code matches with one of the phone codes for a particular website identifier, that particular website will be directed to the user in the same manner as mentioned above.

As an illustration, the computer algorithm leading to the search request web page 11 according to the first preferred embodiment of the present invention is descried as follows:

(1) Showing the language of the search request web page 11;

(2) Enabling Hyperlink for the search request web page 11 to the search-to-be website;

(3) Setting the format of all the fonts and forms shown in the search request web page 11;

(4) Allocate a specific location in the search request web page 11 that allow the browser of the search request web page 11 to enter the numerical search code of the website that he/she wants to find out;

(5) Allocate a specific location in the search request web page 11 that allow the user to activate the searching process.

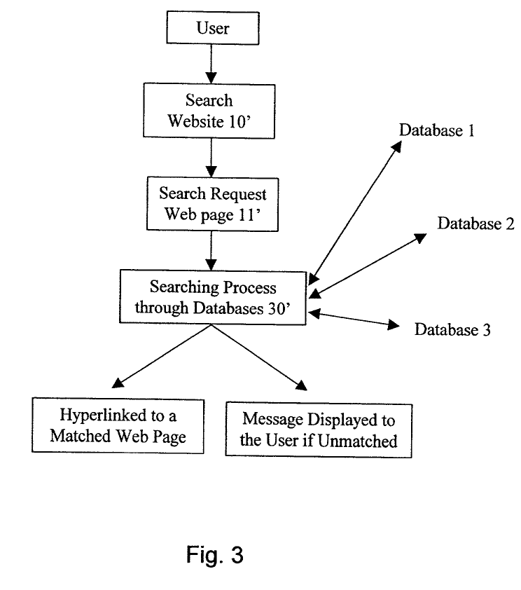

Referring to FIG. 3 of the drawings, a method of searching a specific website by means of a numerical code according to a second preferred embodiment of the present invention is illustrated. According to the second preferred embodiment, the searching method comprises the steps of:

(e) providing an information center which linked to a plurality of databases for storing website identifiers and a plurality of corresponding phone codes, wherein the information center is arranged to be accessed through electronic communication network; and

(f) receiving a search request from a user by the information center via the electronic communication network, wherein the search request includes a numerical search code.

According to the second embodiment, the search website 10′ is linked to several servers 20′, wherein each of the severs 20′ comprises a database 30′ which stores a plurality of website identifiers and their respective phone code. In other words, the database 30′ of the search website 10′ is significantly expanded to include more websites which can be searched by the search website 10′.

Accordingly, the searching method according to the second embodiment further comprises the steps of:

(g) searching the numerical search code from the plurality of databases simultaneously by matching the search code with the phone codes stored in the databases to form a search result; and

(h) providing a search result to the user.

As in the above first preferred embodiment, the searching process is carried out by comparing the entered numerical search code with each of the stored phone codes which represent a unique website from the plurality of databases 30′. If the numerical phone code matches one of the stored phone codes, a search result which contains the corresponding website having a domain name represented by that phone code will be hyperlinked to the user's computer system. In other words, the original search request web page 11′ will be replaced by the web page of the website having the phone code matched with the numerical search code of the user. That is to say, the desirable or the required website is linked automatically to the computer's system via Internet.

However, if the numerical search code doesn't match with all the stored phone codes in the databases 30′, a search result which contains a re-enter web page will be automatically opened which allows the user to enter another numerical search code, and preferably, tells the user that the previous search turns out with no suitable website.

Alternatively, when the numerical search code matches with one of the stored phone codes, a the search result can be shown by opening another web page which is the home page or the web pages of the matched website. In other words, the original search request web page 11′ will not be replaced by the web page of the matched website. In addition, a new search request web page 11′ can be shown to replace the original search report web page for further searching, if desired.

From the forging description, the present invention provides a method for searching a specific website using a unique phone code of that website, therefore reducing the troublesome and problems arising from searching or accessing lengthy domain names of search-to-be websites. Furthermore, due to the uniqueness of each of the phone code for a specific website, the present invention substantially prevents the problem of Cyber-squatters.

What is claimed is:

1. A website searching method, comprising the steps of:
(a) providing an information center linked to at least one database for storing a plurality of website identifiers and a plurality of corresponding unique phone codes of said website identifiers respectively, wherein said information center is arranged to be accessed through electronic communication network;
(b) receiving a search request from a user by said information center, wherein said search request includes a numerical search code;
(c) searching said numerical search code based upon said database by matching said search code with said phone codes stored in said database to form a search result; and
(d) providing said search result to said user.

2. The searching method, as recited in claim 1, wherein each of said phone codes is formed by a combination of an international country code, an area code and a local phone number arranged in a predetermined order, wherein said international country code, area code, and said local phone number are pre-assigned to a host of said corresponding website.

3. The searching method, as recited in claim 1, wherein said step (d) comprises a step of directly hyperlinking a website which has said phone code matched with said numerical search code, so as to display said website to said user.

4. The searching method, as recited in claim 2, wherein said step (d) comprises a step of directly hyperlinking a website which has said phone code matched with said numerical search code, so as to display said website to said user.

5. The searching method, as recited in claim 1, wherein said step (d) comprises a step of displaying a message to said user when said numerical search code is different from said phone codes of said websites stored in said database.

6. The searching method, as recited in claim 2, wherein said step (d) comprises a step of displaying a message to said user when said numerical search code is different from said phone codes of said websites stored in said database.

7. The searching method, as recited in claim 1, wherein each of said website identifier is assigned at least two phone codes such that when said user search said website by said phone codes, said website having said website identifier is directly hyperlinked to said user.

8. The searching method, as recited in claim 4, wherein each of said website identifier is assigned at least two phone codes such that when said user search said website by said phone codes, said website having said website identifier is directly hyperlinked to said user.

9. The searching method, as recited in claim 4, wherein for each of said phone codes, said local phone number is a business phone number said host of said website having said website identifier stored in said database.

10. The searching method, as recited in claim 6, wherein for each of said phone codes, said local phone number is a business phone number of said host of said website having said website identifier stored in said database.

11. The searching method, as recited in claim 7, wherein for each of said phone codes, said local phone number is a business phone number of said host of said website having said website identifier stored in said database.

12. The searching method, as recited in claim 8, wherein for each of said phone codes, said local phone number is a business phone number of said host of said website having said website identifier stored in said database.

13. The searching method, as recited in claim 4, wherein for each of said phone codes, said local phone number is a personal phone number of a representative of said host of said website having said website identifier stored in said database.

14. The searching method, as recited in claim 6, wherein for each of said phone codes, said local phone number is a personal phone number of a representative of said host of said website having said website identifier stored in said database.

15. The searching method, as recited in claim 7, wherein for each of said phone codes, said local phone number is a personal phone number of a representative of said host of said website having said website identifier stored in said database.

16. The searching method, as recited in claim 8, wherein for each of said phone codes, said local phone number is a personal phone number of a representative of said host of said website having said website identifier stored in said database.

17. The searching method, as recited in claim 4, wherein for each of said phone codes, said local phone number is a mobile phone number of a representative of said host of said website having said website identifier stored in said database.

18. The searching method, as recited in claim 6, wherein for each of said phone codes, said local phone number is a mobile phone number of a representative of said host of said website having said website identifier stored in said database.

19. The searching method, as recited in claim 7, wherein for each of said phone codes, said local phone number is a mobile phone number of a representative of said host of said website having said website identifier stored in said database.

20. The searching method, as recited in claim 8, wherein for each of said phone codes, said local phone number is a mobile phone number of a representative of said host of said website having said website identifier stored in said database.
